(19) United States
(12) Patent Application Publication
(10) Pub. No.: US 2022/0173614 A1
(43) Pub. Date: Jun. 2, 2022

(54) POWER RECEIVER APPARATUS AND POWER CONTROL METHOD

(71) Applicant: PANASONIC CORPORATION, Osaka (JP)

(72) Inventors: Tatsuo YAGI, Fukuoka (JP); Shuichiro YAMAGUCHI, Fukuoka (JP)

(73) Assignee: PANASONIC CORPORATION, Osaka (JP)

(21) Appl. No.: 17/535,849

(22) Filed: Nov. 26, 2021

(30) Foreign Application Priority Data
Nov. 30, 2020 (JP) 2020-198635

(51) Int. Cl. H02J 50/10

(52) U.S. Cl. CPC H02J 50/10; H01M 2220/20

(57) ABSTRACT

A power receiver apparatus is movable under water and includes a housing surrounded by a magnetic body. The power receiver apparatus includes: a power receiver device configured to receive power wirelessly transmitted from a power transmitter apparatus; a power supply device including a storage battery and configured to charge the storage battery based on the power received by the power receiver device; a power detection device configured to repeatedly detect a power value during an operation of the power supply device; and a processor configured to determine a control current value for operating the power supply device based on a comparison result between the power value which is detected by the power detection device and a previous power value which has been detected by the power detection device, and to control the operation of the power supply device based on the determined control current value.

### CROSS-REFERENCE TO RELATED APPLICATIONS

This application is based on and claims the benefit of priority of Japanese Patent Application No. 2020-198635 filed on Nov. 30, 2020, the entire contents of which are incorporated herein by reference.

### FIELD

The present disclosure relates to a power receiver apparatus and a power control method.

### BACKGROUND

JP-A-2015-015901 discloses a power transmitter apparatus (for example, an underwater base station) that transmits power underwater in a non-contact manner with a power receiver apparatus (for example, an underwater vehicle) by using a magnetic resonance method. The power transmitter apparatus includes a power transmitter resonance coil, a balloon, and a balloon control mechanism. The power transmitter resonance coil transmits the power to a power receiver resonance coil of the power receiver apparatus in the non-contact manner by using the magnetic resonance method. The balloon includes the power transmitter resonance coil therein. The balloon control mechanism removes water between the power transmitter resonance coil and the power receiver resonance coil by expanding the balloon during power transmission.

### SUMMARY

Here, when it is assumed that power is transmitted underwater from a power transmitter apparatus to a power receiver apparatus, aluminum, which is a weak magnetic body (non-magnetic body), is generally used for a housing of an underwater vehicle (that is, the power receiver apparatus) such as an autonomous underwater vehicle (AUV). When a power receiver coil is formed by winding a wire around a side surface of the housing, an inductance decreases and a Q value decreases due to conductivity of aluminum, which is the weak magnetic body. In order to solve the above problem, by a configuration in which an outer periphery of the housing of the power receiver apparatus is surrounded by a magnetic body formed of a ferromagnetic material, eddy current loss can be reduced and power transmission efficiency can be increased.

However, when the above configuration is adopted, when received power of the power receiver apparatus increases, an effect of reducing the eddy current loss is inhibited by a phenomenon of magnetic saturation of the magnetic body. As a result, the power transmission efficiency to the power receiver apparatus may be decreased. In particular, in wireless power supply to the power receiver apparatus under the water (for example, under the sea), an impedance of a charging battery mounted on the power receiver apparatus or an impedance of a power supply in the power receiver apparatus is likely to vary due to a variation in a coil coupling coefficient based on a position free state of the power receiver apparatus as a moving body. Therefore, it is difficult to determine a condition that does not cause the magnetic saturation.

The present disclosure has been made in view of the above situation in the related art, and provides a power receiver apparatus and a power control method that prevent occurrence of magnetic saturation in the power receiver apparatus under water and improve power transmission efficiency from a power transmitter apparatus even when an outer periphery of a housing is surrounded by a magnetic body.

The present disclosure provides a power receiver apparatus which is movable under water and includes a housing surrounded by a magnetic body on an outer periphery of the housing, the power receiver apparatus including: a power receiver device configured to receive power wirelessly transmitted from a power transmitter apparatus; a power supply device including a storage battery and configured to charge the storage battery based on the power received by the power receiver device; a power detection device configured to repeatedly detect a power value during an operation of the power supply device; and a processor configured to determine a control current value for operating the power supply device based on a comparison result between the power value which is detected by the power detection device and a previous power value which has been detected by the power detection device, and to control the operation of the power supply device based on the determined control current value.

The present disclosure provides a power control method performed by a power receiver apparatus, the power receiver apparatus being movable under water and including a housing surrounded by a magnetic body on an outer periphery of the housing, the power control method including: receiving power wirelessly transmitted from a power transmitter apparatus; charging a storage battery based on power received by a power supply device including the storage battery; repeatedly detecting a power value during an operation of the power supply device; determining a control current value for operating the power supply device based on a comparison result between the power value which is detected and a previous power value which has been detected; and controlling an operation of the power supply device based on the control current value.

According to the present disclosure, even when the outer periphery of the housing is surrounded by the magnetic body, the occurrence of the magnetic saturation in the power receiver apparatus under the water can be prevented, and the power transmission efficiency from the power receiver apparatus can be improved.

### BRIEF DESCRIPTION OF DRAWINGS

FIG. 1 is a diagram schematically showing an example of a use environment in which an underwater power supply system according to a first embodiment is installed.

FIG. 2A is a perspective view schematically showing an example of an appearance of an underwater vehicle.

FIG. 2B is a diagram showing a cross section of the underwater vehicle and a partially enlarged portion thereof as viewed in an arrow F-F direction in FIG. 2A.

FIG. 2C is a diagram showing the cross section of the underwater vehicle and a partially enlarged portion thereof as viewed in an arrow G-G direction in FIG. 2A.

FIG. 3 is a diagram showing a hardware configuration example of the underwater power supply system according to the first embodiment.

FIG. 4 is a block diagram showing a functional configuration example of a receiver-side processor.

FIG. 5 is a graph showing an example of a characteristic indicating a transition of impedance with respect to a load current in a power receiver apparatus.

FIG. 6 is a graph showing an example of a characteristic indicating a transition of a coil current with respect to the impedance in the power receiver apparatus.

FIG. 7 is a graph showing an example of a characteristic indicating a transition of load power with respect to the load current in the power receiver apparatus.

FIG. 8 is a flowchart showing an example of an operation procedure of power control of the power receiver apparatus according to the first embodiment.

### DETAILED DESCRIPTION

Hereinafter, an embodiment specifically disclosing a power receiver apparatus and a power control method according to the present disclosure will be described in detail with reference to the drawings as appropriate. However, an unnecessarily detailed description may be omitted. For example, a detailed description of a well-known matter or a repeated description of substantially the same configuration may be omitted. This is to avoid unnecessary redundancy in the following description and to facilitate understanding of those skilled in the art. The accompanying drawings and the following description are provided for a thorough understanding of the present disclosure for those skilled in the art, and are not intended to limit the subject matter in the claims.

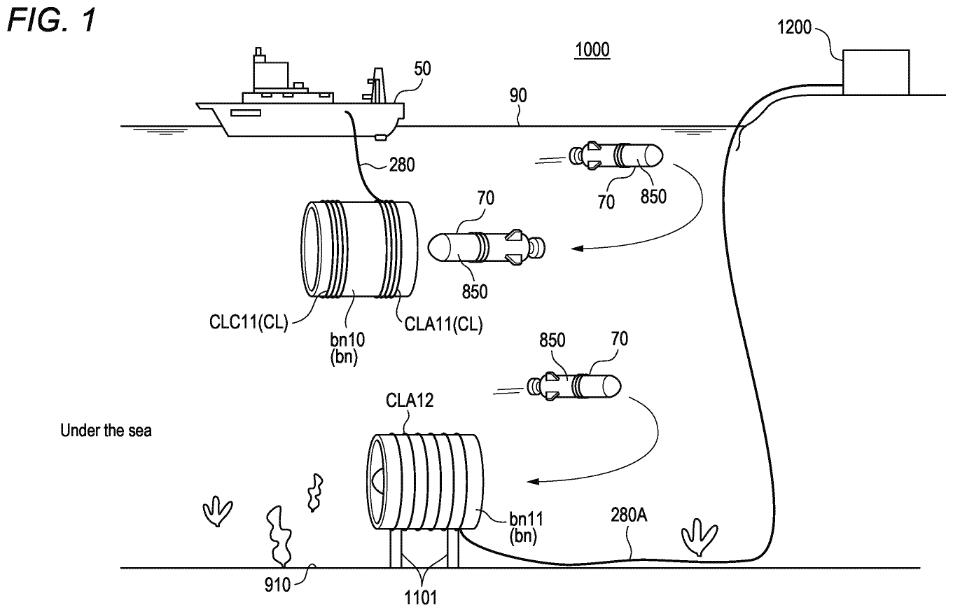

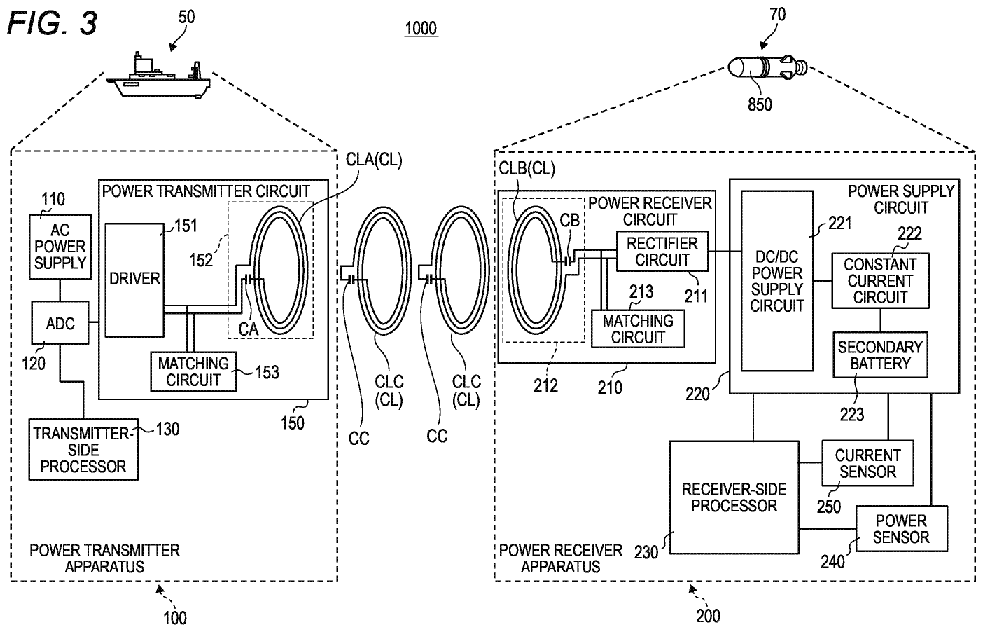

FIG. 1 is a diagram schematically showing an example of a use environment in which an underwater power supply system 1000 according to a first embodiment is installed. The underwater power supply system 1000 includes a power transmitter apparatus 100, a power receiver apparatus 200, and a plurality of coils CL (see FIG. 3). The power transmitter apparatus 100 wirelessly (that is, contactlessly) transmits power to the power receiver apparatus 200 via the plurality of coils CL in accordance with a magnetic resonance method. The number of coils CL to be disposed is n (n is an integer of 2 or more), and can be freely set.

Each of the coils CL is formed into, for example, an annular shape, and is insulated by being covered with a resin cover. The coil CL is formed of, for example, a cab tire cable, a helical coil, or a spiral coil. The helical coil is an annular coil that is wound not in the same plane and is spirally wound along a transmission direction of the power by the magnetic resonance method. The spiral coil is an annular coil formed in a spiral shape in the same plane. It is possible to reduce a thickness of the coil CL by adopting the spiral coil. It is possible to secure a large space inside the wound coil CL by adopting the helical coil. FIG. 1 illustrates an example of the spiral coil.

The coils CL used for power transmission include a power transmitter coil CLA and a power receiver coil CLB. The power transmitter coil CLA is a primary coil. The power receiver coil CLB is a secondary coil. The coils CL may include at least one relay coil CLC (booster coil) disposed between the power transmitter coil CLA and the power receiver coil CLB. The relay coil CLC is an example of the power transmitter coil. When there are a plurality of relay coils CLC, the relay coils CLC are disposed substantially parallel to one another, and half or more of opening surfaces formed by the relay coils CLC overlap one another. An interval between the plurality of relay coils CLC is ensured to be equal to or larger than, for example, a radius of the relay coil CLC. The relay coils CLC assist the power transmission performed by the power transmitter coil CLA.

The power transmitter coil CLA is provided in the power transmitter apparatus 100 (see FIG. 3). The power receiver coil CLB is provided in the power receiver apparatus 200 (see FIG. 3). The relay coils CLC may be provided in the power transmitter apparatus 100, may be provided in the power receiver apparatus 200, or may be provided separately from the power transmitter apparatus 100 and the power receiver apparatus 200. Alternatively, a part of the relay coils CLC may be provided in the power transmitter apparatus 100, and the other relay coils CLC may be provided in the power receiver apparatus 200.

A part of the power transmitter apparatus 100 may be provided in a ship 50, the other part of the power transmitter apparatus 100 may be provided in, for example, a power supply facility 1200 installed on land. The power receiver apparatus 200 may be set in a movable underwater vehicle 70 (for example, an underwater watercraft or an underwater excavator), or may be installed in a fixed underwater facility (for example, a seismometer, a monitoring camera, or a geothermal power generator). FIG. 1 illustrates the underwater watercraft as an example of the underwater vehicle 70. The coils CL are disposed under the water (for example, under the sea).

Examples of the underwater vehicle 70 may be a remotely operated vehicle (ROV), an unmanned underwater vehicle (UUV), and an autonomous underwater vehicle (AUV).

A part of the ship 50 is present above a water surface 90 (for example, a sea surface), that is, above the water, and the other part of the ship 50 is present below the water surface 90, that is, under the water (for example, under the sea). The ship 50 is movable above the water (for example, on the sea). For example, the ship 50 is freely movable above the water at a data acquisition location (for example, on the sea). The power transmitter apparatus 100 installed in the ship 50 and the power transmitter coil CLA are connected to each other by a power cable 280. The power cable 280 is connected to a driver 151 in the power transmitter apparatus 100 (see FIG. 3) via a connector above the water.

The underwater vehicle 70 submerges under the water, and is freely movable to a predetermined data acquisition point based on an instruction from the ship 50. The instruction from the ship 50 may be transmitted by communication via the coils CL, or may be transmitted using other communication methods.

The coils CL are disposed, for example, at equal intervals. A distance (coil interval) between adjacent coils CL is, for example, 5 m. For example, the coil interval has a length equal to about half of a diameter of the coil CL. A transmission frequency is, for example, 40 kHz or less and is preferably less than 10 kHz in consideration of attenuation of a magnetic field strength under the water (for example, under the sea). When the power transmission is performed at the transmission frequency of 10 kHz or more, it is required to perform a predetermined simulation based on provisions of the Radio Act. When the transmission frequency is less than 10 kHz, the simulation can be omitted. When the transmission frequency becomes lower, a power transmission distance becomes longer, the coil CL becomes larger, and the coil interval becomes larger. For example, when communication signals are superimposed, the transmission frequency may be a frequency higher than 40 kHz.

The transmission frequency is determined based on coil characteristics such as an inductance of the coil CL, a diameter of the coil CL, and the number of turns of the coil CL. The diameter of the coil CL is, for example, several meters to several tens of meters. When a thickness of the coil CL increases, that is, when a wire diameter of the coil CL increases, electrical resistance in the coil CL decreases, and power loss decreases. The power transmitted via the coil CL is, for example, 50 W or more, and may be on an order of kW.

The power transmitter apparatus 100 may include one or more bobbins bn around which the wire of the coil is wound. A material of the bobbin bn may use a non-conductive or weak magnetic material (for example, a resin such as polyvinyl chloride, acrylic, and polyester). The material of the bobbin bn may have dielectric property. For example, when polyvinyl chloride is used as the material of the bobbin bn, the bobbin bn is inexpensive, easily available, and easily processed. Since the bobbin bn is non-conductive, a magnetic field generated due to an alternating current (AC) flowing through the coil CL can be prevented from being absorbed by the bobbin bn in the power transmitter apparatus 100. In FIG. 1, in order to supply the power under the water (for example, supply the power under the sea), there are provided a power supply stand including a bobbin bn10 that floats under the water and a power supply stand including a bobbin bn11 disposed on a seabed.

In the power supply stand including the bobbin bn10, a power transmitter coil CLA11 and a relay coil CLC11 are wound around an outer periphery of the cylindrical bobbin bn10. The power cable 280 is connected to the power transmitter coil CLA11. The power is supplied, via the power cable 280, to the power transmitter coil CLA11 from the ship 50 mooring on the sea. The power cable 280 supports the power supply stand in a floating state under the sea. In the floating state, openings on two sides of the cylindrical bobbin bn10 may be oriented in a horizontal direction. The underwater vehicle 70 may enter, in the horizontal direction, an entrance and exit of the power supply stand in the floating state and stay inside the bobbin bn10 to receive the power.

The power supply stand including the bobbin bn11 is fixed to upper portions of two pillars 1101 embedded in a seabed 910. The entrance and exit of the power supply stand may be oriented in the horizontal direction. In the power supply stand, the power transmitter coil CLA12 is wound around the cylindrical bobbin bn11, whereas the relay coil CLC is not disposed. For example, a power cable 280A extending along the seabed 910 may be connected to the power transmitter coil CLA12. The power may be supplied from the power supply facility 1200 via the power cable 280A. The underwater vehicle 70 may enter, in the horizontal direction, the entrance and exit of the power supply stand installed on the seabed 910 and stay inside the bobbin bn11 to receive the power.

Here, on the outer periphery of the housing of the underwater vehicle 70 according to the first embodiment, a magnetic body (refer to the following description) is provided so as to cover the entire outer periphery. This is to reduce eddy current loss in the underwater vehicle 70 (in other words, the power receiver apparatus 200) and increase power transmission efficiency from the power transmitter apparatus 100.

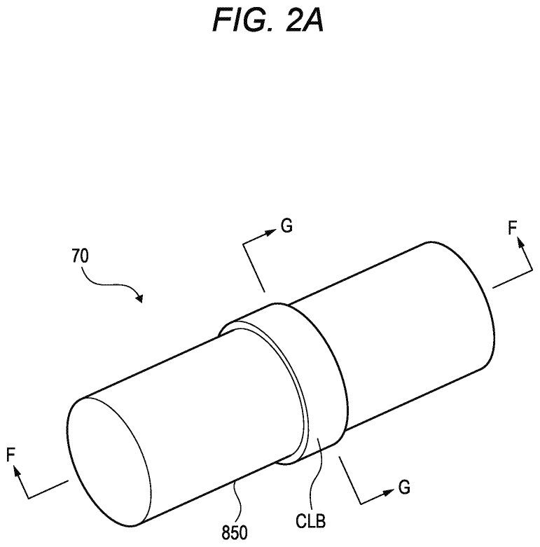

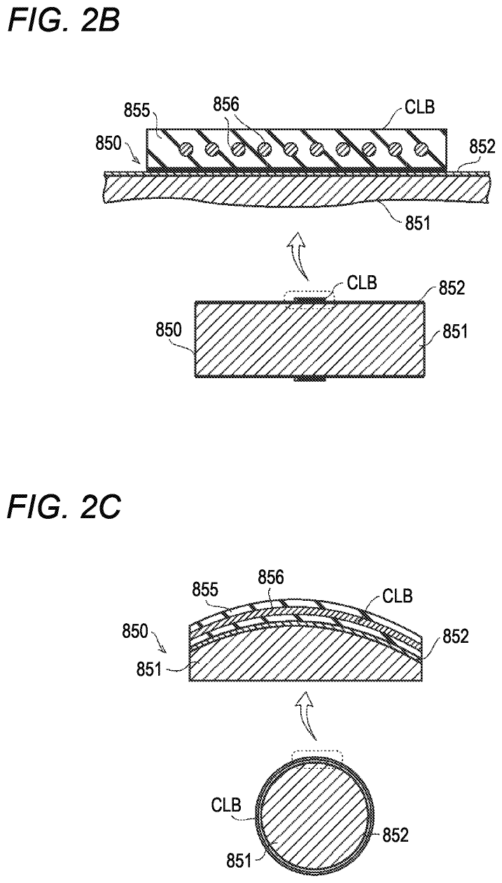

Next, a positional relationship between the underwater vehicle 70 and the magnetic body will be described with reference to FIGS. 2A to 2C. FIG. 2A is a perspective view schematically showing an example of an appearance of the underwater vehicle 70. FIG. 2B is a diagram showing a cross section of the underwater vehicle 70 and a partially enlarged portion thereof as viewed in an arrow F-F direction in FIG. 2A. FIG. 2C is a diagram showing a cross section of the underwater vehicle 70 and a partially enlarged portion thereof as viewed in an arrow G-G direction in FIG. 2A.

The underwater vehicle 70 has a structure including a core 850 which is a magnetic body having high magnetic permeability (that is, a ferromagnetic material), and a power receiver coil CLB which is disposed so as to wind the core 850. The core 850 may be configured by a housing (for example, a weak magnetic body 851 such as aluminum) of the underwater vehicle 70 and a magnetic body (for example, a ferrite 852) wound around the housing. The core 850 may be formed by attaching a magnetic material to a side surface of a columnar weak magnetic body simulating the housing of the underwater vehicle 70. The magnetic body may be formed into a cylindrical shape along the side surface of the columnar weak magnetic body, or may be formed into a sheet shape so as to be attached to the side surface of the weak magnetic body. The magnetic body is not limited to the side surface of the columnar weak magnetic body (for example, the side surface of the housing of the underwater vehicle 70). The magnetic body may be attached to a front surface of the weak magnetic body (for example, a front surface of the housing of the underwater vehicle 70) and a rear surface thereof (for example, a rear surface of the housing of the underwater vehicle 70). The cylindrical weak magnetic body may use, for example, aluminum that is light, rust resistant, and easy to cut. The weak magnetic body is not limited to aluminum, and may use stainless steel, titanium, resin, and the like. As an example of the magnetic material, the ferrite 852 having a thickness of 2 mm is used in the first embodiment. Since electricity is difficult to pass the ferrite, heat generation is little even when the magnetic field is generated. Since the ferrite is rust resistant, the ferrite can be easily handled. The magnetic material (ferromagnetic material) is not limited to the ferrite. A silicon steel plate, permalloy, or the like can also be used. The ferromagnetic material has higher magnetic permeability than the weak magnetic material.

When the core 850 is provided inside the power receiver coil CLB, a magnetic field generated by the power transmitter coil CLA or the relay coil CLC is concentrated inside the ferrite 852 provided in the core 850, and a magnetic flux is generated inside the ferrite 852 due to the generated magnetic field. Accordingly, in the underwater vehicle 70, a large number of lines of magnetic force gather inside the power receiver coil CLB. Therefore, a decrease in the power transmission efficiency from the power transmitter apparatus 100 is prevented.

When the underwater vehicle 70 enters the inside of the relay coil CLC and reaches a position where the relay coil CLC and the power receiver coil CLB face each other on substantially the same plane, wireless power supply is started under the water. The same applies to a case where the underwater vehicle 70 enters the inside of the power transmitter coil CLA from a power transmitter coil CLA side instead of the relay coil CLC. When the power transmitter coil CLA and the power receiver coil CLB reach a position facing each other on substantially the same plane, the wireless power supply is started under the water.

The power receiver coil CLB is formed by, for example, sealing a 10-turn electric wire 856 with a covering material 855. The covering material 855 may be a material having insulation, elasticity, and weather resistance. Here, the covering material 855 may use rubber. The underwater vehicle 70 is integrated by attaching the molded power receiver coil CLB to the outer periphery of the core 850. An adhesive may be applied to a contact surface between the outer periphery of the core 850 and the covering material 855 of the power receiver coil CLB so that the core 850 and the covering material 855 are not separated. The core 850 and the power receiver coil CLB may be integrated using a method other than adhesion using the adhesive.

FIG. 3 is a diagram showing a hardware configuration example of the underwater power supply system 1000 according to the first embodiment. As described above, the underwater power supply system 1000 includes the power transmitter apparatus 100, the power receiver apparatus 200, and the plurality of coils CL.

The power transmitter apparatus 100 includes an AC power supply 110, an AC/DC converter (ADC) 120, a transmitter-side processor 130, and a power transmitter circuit 150.

The ADC 120 converts AC power supplied from the AC power supply 110, which is an example of a power supply for power transmission, into DC power. The converted DC power is transmitted to the power transmitter circuit 150.

The transmitter-side processor 130 is configured by using, for example, a central processing unit (CPU), and integrally controls an operation of each unit of the power transmitter apparatus 100 (for example, the AC power supply 110, the ADC 120, and the power transmitter circuit 150).

The power transmitter circuit 150 includes the driver 151, a resonance circuit 152, and a matching circuit 153. The driver 151 converts the DC power from the ADC 120 into an AC voltage of a predetermined frequency (for example, a pulse waveform). The resonance circuit 152 includes a capacitor CA and a power transmitter coil CLA, and generates an AC voltage having a sinusoidal waveform based on the AC voltage having the pulse waveform from the driver 151. The power transmitter coil CLA resonates at a predetermined resonance frequency in accordance with the AC voltage applied from the driver 151. The power transmitter coil CLA is impedance-matched to an output impedance of the power transmitter apparatus 100 by the matching circuit 153.

A frequency of the AC voltage obtained by conversion by the driver 151 corresponds to a transmission frequency of power transmission between the power transmitter apparatus 100 and the power receiver apparatus 200, and corresponds to a resonance frequency. The transmission frequency may be set based on, for example, a Q value of each coil CL.

Although not shown in FIG. 3, the power transmitter apparatus 100 may further include a communication device (not shown) for data communication. The communication device includes, for example, a PLC adapter corresponding to power line communication (PLC) communication and a modulation and demodulation circuit for modulating or demodulating communication data communicated between the power transmitter apparatus 100 and the power receiver apparatus 200. The modulation and demodulation circuit may be provided in the PLC adapter. The communication device transmits, for example, control information from the power transmitter apparatus 100 to the power receiver apparatus 200 via the PLC adapter (not shown) and the coil CL. The communication device receives, for example, data from the power receiver apparatus 200 to the power receiver apparatus 100 via the coil CL and the PLC adapter. The data includes, for example, data on an exploration result obtained by underwater exploration or bottom exploration by the underwater vehicle 70. The communication device can quickly perform data communication with the underwater vehicle 70 (in other words, the power receiver apparatus 200) while the underwater vehicle 70 performs work such as data collection.

The power receiver apparatus 200 includes a power receiver circuit 210, a power supply circuit 220, a receiver-side processor 230, a power sensor 240, and a current sensor 250.

The power receiver circuit 210 includes a rectifier circuit 211, a resonance circuit 212, and a matching circuit 213. The rectifier circuit 211 converts AC power induced in the power receiver coil CLB into DC power. The resonance circuit 212 includes a capacitor CB and the power receiver coil CLB, and receives the AC power transmitted from the power transmitter coil CLA. The power receiver coil CLB is impedance-matched to an input impedance of the power receiver apparatus 200 by the matching circuit 213.

The power supply circuit 220 includes a DC/DC power supply circuit 221, a constant current circuit 222, and a secondary battery 223 as an example of a storage battery. The DC/DC power supply circuit 221 configures a power supply circuit in which one or more general-purpose circuit components (for example, a DC/DC converter) are used as a power supply for charging the secondary battery 223 in the underwater power supply system 1000. The DC/DC power supply circuit 221 boosts or lowers the DC power from the power receiver circuit 210 based on a control signal from the receiver-side processor 230, and supplies the DC power to the constant current circuit 222. Based on a power supply voltage supplied from the DC/DC power supply circuit 221, the constant current circuit 222 controls charging or discharging of the secondary battery 223 by supplying a constant charging current corresponding to a type of the secondary battery 223 to the secondary battery 223. The secondary battery 223 stores the power transmitted from the power transmitter apparatus 100. The secondary battery 223 is, for example, a lithium ion battery.

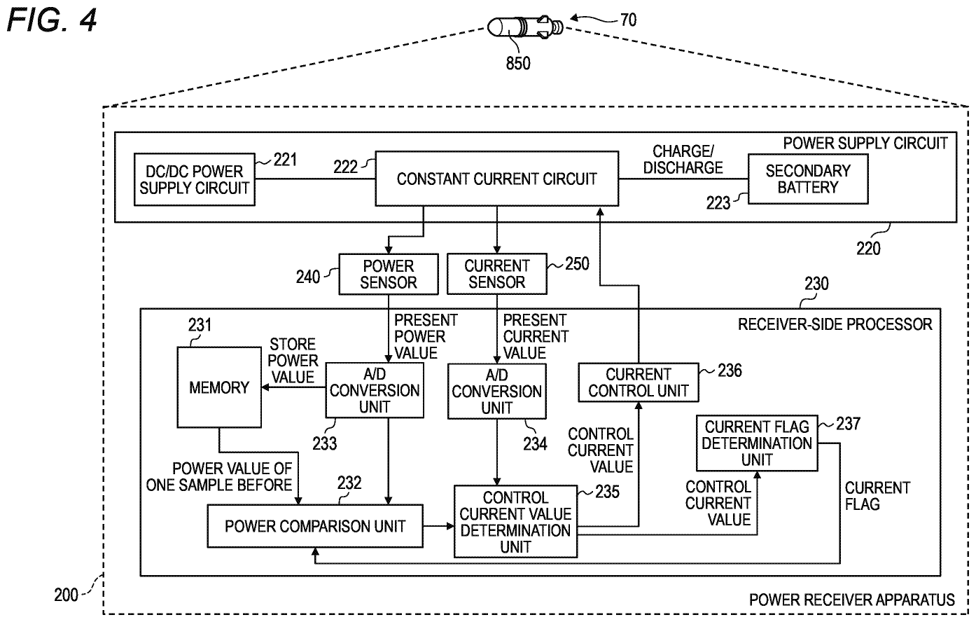

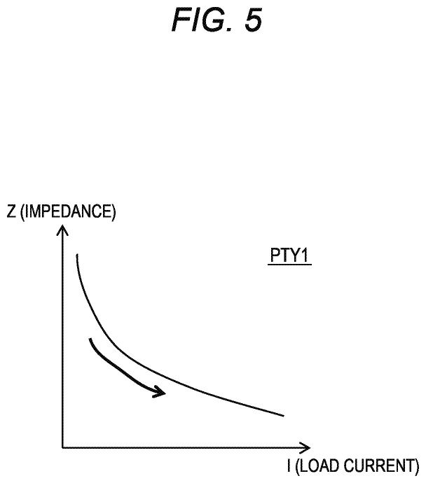

The receiver-side processor 230 is configured by using, for example, a CPU, and controls an operation of each unit of the power receiver apparatus 200 (for example, the power receiver circuit 210, the power supply circuit 220, the power sensor 240, and the current sensor 250). The receiver-side processor 230 executes periodic interrupt processing for periodically controlling the charging current from the constant current circuit 222 to the secondary battery 223 (see FIGS. 5 to 8). The periodic interrupt processing is executed, for example, every 10 ms. Details of the receiver-side processor 230 will be described later with reference to FIG. 4.

The power sensor 240 detects power corresponding to the power supply voltage supplied from the DC/DC power supply circuit 221 by the constant current circuit 222 of the power supply circuit 220 in synchronization with a timing of the above periodic interrupt processing, and sends the power to the receiver-side processor 230.

The current sensor 250 detects a current supplied to the secondary battery 223 (that is, the charging current) by the constant current circuit 222 of the power supply circuit 220 in synchronization with the timing of the above periodic interrupt processing, and sends the current to the receiver-side processor 230.

Although not shown in FIG. 3, the power receiver apparatus 200 may further include a communication device (not shown) for data communication. The communication device includes, for example, a PLC adapter corresponding to the PLC communication, and a modulation and demodulation circuit for modulating or demodulating communication data communicated between the power receiver apparatus 200 and the power transmitter apparatus 100. The modulation and demodulation circuit may be provided in the PLC adapter. The communication device receives, for example, control information from the power transmitter apparatus 100 to the power receiver apparatus 200 via the coil CL and the PLC adapter. The communication device transmits, for example, data from the power receiver apparatus 200 to the power transmitter apparatus 100 via the PLC adapter and the coil CL. The data includes, for example, data on an exploration result obtained by underwater exploration or bottom exploration by the underwater vehicle 70. The communication device can quickly perform the data communication with the ship 50 (in other words, the power transmitter apparatus 100) while the underwater vehicle 70 performs the work such as the data collection.

Similar to the power transmitter coil CLA and the power receiver coil CLB, the relay coil CLC configures a resonance circuit together with a capacitor CC. That is, in the present embodiment, resonance circuits are disposed in multiple stages under the water, so that the power is transmitted using the magnetic resonance method.

Here, the power transmission from the power transmitter apparatus 100 to the power receiver apparatus 200 will be briefly described with reference to FIG. 3.

In the resonance circuit 152 of the power transmitter apparatus 100, when a current flows through the power transmitter coil CLA of the power transmitter apparatus 100, a magnetic field is generated around the power transmitter coil CLA. Vibration of the generated magnetic field is transmitted to a resonance circuit including the relay coil CLC that resonates at the same frequency as the resonance frequency of the resonance circuit 152.

In the resonance circuit including the relay coil CLC, a current is excited in the relay coil CLC due to the vibration of the magnetic field. The current flows, and a magnetic field is further generated around the relay coil CLC. The vibration of the generated magnetic field is transmitted to a resonance circuit including other relay coil CLC that resonates at the same frequency as the resonance frequency of the resonance circuit 152 and the resonance circuit 212 including the power receiver coil CLB.

In the resonance circuit 212 of the power receiver apparatus 200, an alternating current is induced in the power receiver coil CLB by the vibration of the magnetic field of the relay coil CLC. The induced alternating current is rectified by the rectifier circuit 211, converted into a predetermined voltage in the power supply circuit 220, and a charging current flows, so that the secondary battery 223 is charged.

Next, a configuration example of the receiver-side processor 230 will be described with reference to FIG. 4. FIG. 4 is a block diagram showing a functional configuration example of the receiver-side processor 230. The receiver-side processor 230 includes a memory 231, a power comparison unit 232, A/D conversion units 233 and 234, a control current value determination unit 235, a current control unit 236, and a current flag determination unit 237.

The memory 231 stores data or a program referred to during processing executed by the receiver-side processor 230, and temporarily stores data generated during the processing executed by the receiver-side processor 230. The memory 231 stores, for example, a power value converted by the A/D conversion unit 233.

The power comparison unit 232 compares a power value of a previous sample stored in the memory 231 (for example, a power value detected at the time of previous periodic interrupt processing) with a present (latest) power value converted by the A/D conversion unit 233. The power comparison unit 232 sends a comparison result and a current flag from the current flag determination unit 237 (that is, a current flag determined during the previous periodic interrupt processing, which will be referred to later) to the control current value determination unit 235.

The A/D conversion unit 233 converts the present power value detected by the power sensor 240 every time the periodic interrupt processing is performed into a digital value, stores the power value of the digital value in the memory 231, and sends the power value of the digital value to the power comparison unit 232.

The A/D conversion unit 234 converts a present current value detected by the current sensor 250 every time the periodic interrupt processing is performed into a digital value, and sends the current value of the digital value to the control current value determination unit 235.

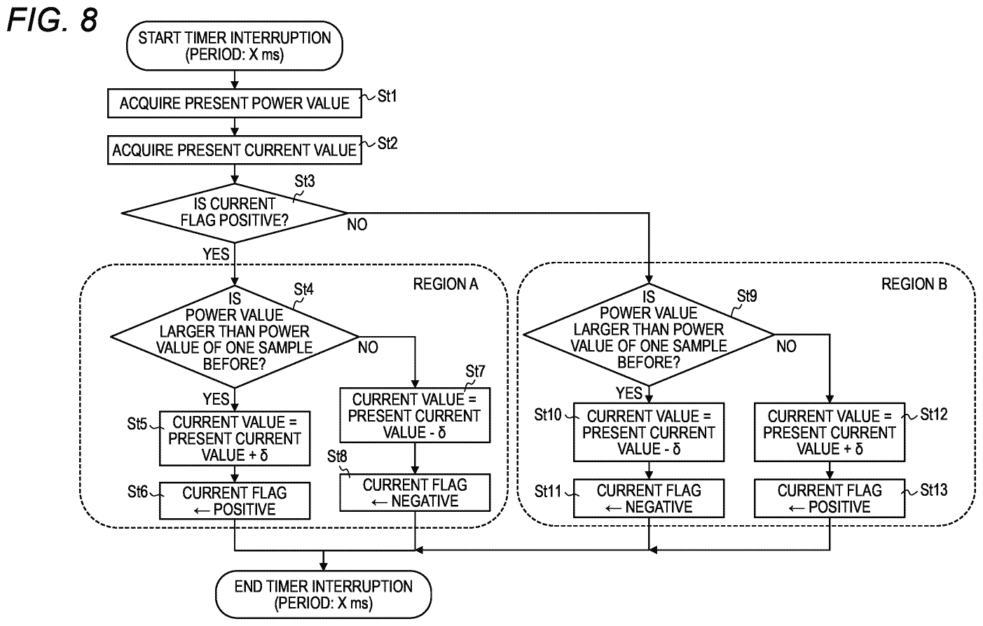

The control current value determination unit 235 determines, based on an output from the power comparison unit 232 and the present current value converted by the A/D conversion unit 234, a constant charging current to be supplied from the constant current circuit 222 to the secondary battery 223 as a control current value, and sends the control current value to each of the current control unit 236 and the current flag determination unit 237. Details of the determination of the control current value will be described later with reference to FIG. 8.

The current control unit 236 generates a control signal for supplying the constant charging current from the constant current circuit 222 to the secondary battery 223 based on the output from the control current value determination unit 235 (that is, the control current value), and sends the control signal to the constant current circuit 222 of the power supply circuit 220.

The current flag determination unit 237 determines, based on the output from the control current value determination unit 235 (that is, the control current value), a current flag (positive current flag) indicating that the control current value is to be increased more than the previous current value that has been determined one sample before (that is, the control current value determined at the time of the previous periodic interrupt processing) or a current flag (negative current flag) indicating that the control current value is to be decreased more than the previous current value that has been determined one sample before (that is, the control current value determined at the time of the previous periodic interrupt processing). The current flag determination unit 237 sends a determination result of the current flag to the power comparison unit 232.

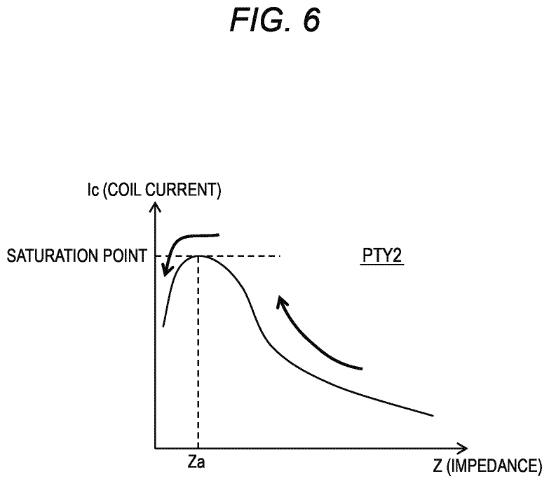

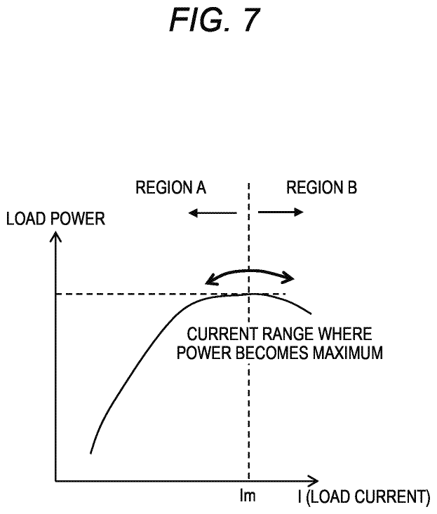

Next, an example of an operation procedure of periodic control of the power control in the power receiver apparatus 200 according to the first embodiment will be described with reference to FIGS. 5 to 8. FIG. 5 is a graph showing an example of a characteristic indicating a transition of impedance with respect to a load current in the power receiver apparatus. FIG. 6 is a graph illustrating an example of a characteristic indicating a transition of a coil current with respect to the impedance in the power receiver apparatus. FIG. 7 is a graph showing an example of a characteristic indicating a transition of load power with respect to the load current in the power receiver apparatus. FIG. 8 is a flowchart showing the example of the operation procedure of the power control of the power receiver apparatus 200 according to the first embodiment. Processing in FIG. 8 is mainly executed by the receiver-side processor 230 at predetermined intervals (X milliseconds). X is, for example, 10.

When adopting a configuration in which the outer periphery of the housing is covered with the magnetic body (see FIGS. 2A to 2C) as in the underwater vehicle 70 according to the first embodiment, as shown in FIG. 5, a characteristic PTY1 shown between a load current I of the power receiver apparatus 200 and an impedance Z of the power receiver apparatus 200 is obtained. That is, when the load current I increases, the impedance Z decreases. The load current I is a current corresponding to the power supply voltage supplied from the DC/DC power supply circuit 221 to the constant current circuit 222. The impedance Z is an impedance of the power receiver circuit 210.

When adopting the configuration in which the outer periphery of the housing is covered with the magnetic body (see FIGS. 2A to 2C) as in the underwater vehicle 70 according to the first embodiment, as shown in FIG. 6, a characteristic PTY2 shown between the impedance Z (see the above description) of the power receiver apparatus 200 and a coil current Ic of the power receiver apparatus 200 is obtained. That is, when the load current I is increased and the impedance Z is decreased, the coil current Ic (that is, a current flowing through the power receiver coil CLB of the power receiver circuit 210) is increased. When the impedance becomes lower than a certain impedance Za, magnetic saturation occurs and the coil current Ic starts to decrease.

Therefore, when adopting the configuration in which the outer periphery of the housing is covered with the magnetic body (see FIGS. 2A to 2C) as in the underwater vehicle 70 according to the first embodiment, as shown in FIG. 7, a characteristic PTY3 that maximizes the load power (in other words, the power supplied to the constant current circuit 222) is obtained immediately before the occurrence of the magnetic saturation (see the above description) or immediately after the occurrence of the magnetic saturation (see the above description).

With the characteristic, the power receiver apparatus 200 according to the first embodiment performs control while monitoring the load current I in the receiver-side processor 230 so that the load power is maximized.

Specifically, in the case of the characteristic in which the load current I is less than 1 m (in other words, in a region A where the characteristic in which the load power increases as the load current I increases is obtained), the receiver-side processor 230 controls the load current to gradually increase. In the case of the characteristic in which the load current I is not less than 1 m (in other words, in a region B where the characteristic in which the load power decreases as the load current I increases is obtained), the receiver-side processor 230 controls the load current to gradually decrease.

In FIG. 8, the receiver-side processor 230 acquires a present power value from the power sensor 240 (St1) and acquires a present current value from the current sensor 250 (St2). The receiver-side processor 230 determines, based on an output from the current flag determination unit 237, whether a current flag determined in the previous periodic interrupt processing is positive (St3).

When the receiver-side processor 230 determines that the current flag is positive (YES in St3), the control current value is increased at the time of the previous periodic interrupt processing. Therefore, the receiver-side processor 230 regards a present state as in the region A and performs processing in step St4.

That is, the receiver-side processor 230 determines whether the present power value acquired in step St1 is larger than the previous power value that has been acquired one sample before (St4). When the receiver-side processor 230 determines that the present power value acquired in step St1 is larger than the previous power value that has been acquired one sample before (YES in St4), the receiver-side processor 230 determines a value obtained by adding a predetermined value δ (for example, a minute value of about 10 mA) to the present current value acquired in step St2 as a control current value (St5), and determines the current flag corresponding to the present periodic interrupt processing as the positive current flag (St6). This is because it can be determined from a determination result in step St4 that a polarity of the present load power is not inverted (in other words, the load power does not pass a maximum value) in the region A since it is determined that the current flag is positive in the previous periodic interrupt processing.

On the other hand, when the receiver-side processor 230 determines that the present power value acquired in step St1 is smaller than the previous power value that has been acquired one sample before (NO in St4), the receiver-side processor 230 determines a value obtained by subtracting the predetermined value δ (for example, the minute value of about 10 mA) from the present current value acquired in step St2 as the control current value (St7), and determines the current flag corresponding to the present periodic interrupt processing as the negative current flag (St8). This is because it can be determined from the determination result in step St4 that the polarity of the present load power is inverted (in other words, the load power passes through the maximum value and turns to decrease) in the region A since it is determined that the current flag is positive in the previous periodic interrupt processing.

When the receiver-side processor 230 determines that the current flag is negative (NO in St3), the control current value is decreased at the time of the previous periodic interrupt processing. Therefore, the receiver-side processor 230 regards the present state as in the region B and performs processing in step St9.

The receiver-side processor 230 determines whether the present power value acquired in step St1 is larger than the previous power value that has been acquired one sample before (St9). When the receiver-side processor 230 determines that the present power value acquired in step St1 is larger than the previous power value that has been acquired one sample before (YES in St10), the receiver-side processor 230 determines a value obtained by subtracting the predetermined value δ (for example, the minute value of about 10 mA) from the present current value acquired in step St2 as the control current value (St10), and determines the current flag corresponding to the present periodic interrupt processing as the negative current flag (St11). This is because it can be determined from a determination result in step St9 that the polarity of the present load power is not inverted (in other words, the load power does not pass through the maximum value) in the region B since it is determined that the current flag is negative in the previous periodic interrupt processing.

On the other hand, when the receiver-side processor 230 determines that the present power value acquired in step St1 is smaller than the previous power value that has been acquired one sample before (NO in St9), the receiver-side processor 230 determines a value obtained by adding the predetermined value δ to the present current value acquired in step St2 as the control current value (St12), and determines the current flag corresponding to the present periodic interrupt processing as the positive current flag (St13). This is because it can be determined from the determination result in step St9 that the polarity of the present load power is inverted (in other words, the load power passes through the maximum value and turns to decrease) in the region B since it is determined that the current flag is negative in the previous periodic interrupt processing.

As described above, in the underwater power supply system 1000 according to the first embodiment, the power receiver apparatus 200 is movable under the water, and includes the housing surrounded by the magnetic body (for example, the core 850) on an outer periphery of the housing. The power receiver apparatus 200 includes a power receiver device (for example, the power receiver circuit 210) configured to receive power wirelessly transmitted from the power transmitter apparatus 100, a power supply device (for example, the power supply circuit 220) including a storage battery (for example, the secondary battery 223) and configured to charge the storage battery based on the power received by the power receiver device, a power detection device (for example, the power sensor 240) configured to repeatedly detect a power value during operation of the power supply device, and a processor (for example, the receiver-side processor 230) configured to determine a control current value for operating the power supply device based on a comparison result between the power value which is detected by the power detection device and a previous power value which has been detected by the power detection device, and to control the operation of the power supply device based on the control current value.

Accordingly, even when the outer periphery of the housing of the underwater vehicle 70 in which the power receiver apparatus 200 is mounted is surrounded by the magnetic body (for example, the ferrite 852), the power receiver apparatus 200 can prevent the occurrence of the magnetic saturation in the power receiver apparatus 200 under the water, and can improve the power transmission efficiency from the power transmitter apparatus 100.

The power detection device may be configured to periodically detect the power value at a predetermined period during the operation of the power supply device. The previous power value is a power value which has been detected one period before in the predetermined period (for example, 10 milliseconds before). Accordingly, the power receiver apparatus 200 can periodically determine whether a certain amount of charging current to be supplied at the time of charging in the power supply device (for example, the power supply circuit 220) can be maximized.

The power receiver apparatus 200 may further include: a current detection device (for example, the current sensor 250) configured toto repeatedly detect a current value during the operation of the power supply device. The processor may be configured to increase or decrease the control current value with reference to the current value detected by the current detection device. Accordingly, the power receiver apparatus 200 can adjust a value of the load current so as to be a value before and after the load current when the magnetic saturation occurs, and can adaptively improve the power transmission efficiency from the power transmitter apparatus 100.

In a case in which the processor has increased a previous control current value and in a case in which the power value detected by the power detection device is larger than the previous power value, the processor may be configured to increase the current value detected by the current detection device by a predetermined amount δ. Accordingly, the power receiver apparatus 200 can efficiently maximize the load power based on a magnitude relationship between the detected present power value and the power value detected at the time of the previous periodic interrupt processing in view of the characteristic of the present load current and the load power in which the load power increases as the load current increases.

In a case in which the processor has increased a previous control current value and in a case in which the power value detected by the power detection device is smaller than the previous power value, the processor may be configured to decrease the current value detected by the current detection device by the predetermined amount δ. Accordingly, the power receiver apparatus 200 can efficiently maximize the load power based on the magnitude relationship between the detected present power value and the power value detected at the time of the previous periodic interrupt processing in view of the characteristic of the present load current and the load power in which the load power decreases as the load current increases.

In a case in which the processor 230 has decreased a previous control current value and in a case in which the power value detected by the power detection device is larger than the previous power value, the processor may be configured to decrease the current value detected by the current detection device by the predetermined amount δ. Accordingly, the power receiver apparatus 200 can efficiently maximize the load power based on the magnitude relationship between the detected present power value and the power value detected at the time of the previous periodic interrupt processing in view of the characteristic of the present load current and the load power in which the load power decreases as the load current increases.

In a case in which the processor has decreased a previous control current value and in a case in which the power value detected by the power detection device is smaller than the previous power value, the processor may be configured to increase the current value detected by the current detection device by the predetermined amount δ. Accordingly, the power receiver apparatus 200 can efficiently maximize the load power based on the magnitude relationship between the detected present power value and the power value detected at the time of the previous periodic interrupt processing in view of the characteristic of the present load current and the load power in which the load power decreases as the load current increases.

Although various embodiments are described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present disclosure. Components in the various embodiments mentioned above may be combined as desired in the range without departing from the spirit of the invention.

In the present embodiment described above, the power receiver apparatus 200 may be a generator or the like installed on the seabed. In this case, the power receiver apparatus 200 is fixedly installed under the water. In this manner, in a structure fixedly installed on the seabed, even when it is difficult to move and charge the structure, since the power transmitter apparatus 100 approaches the power receiver apparatus 200, the power transmission efficiency under the water can be improved and the structure can be charged.

In the present embodiment described above, although the power transmitter coil CLA and the plurality of relay coils CLC are disposed in a lateral direction (horizontal direction) under the sea, the power transmitter coil CLA and the plurality of relay coils CLC may be disposed in a longitudinal direction (vertical direction). When the power transmitter coil CLA and the plurality of relay coils CLC are disposed in the longitudinal direction, surfaces of the power transmitter coil CLA and the relay coils CLC are substantially parallel to the water surface. When the power transmitter coil CLA and the plurality of relay coils CLC are disposed in the longitudinal direction, the power receiver coils CLB mounted on the underwater vehicle 70 may also be mounted in the longitudinal direction so as to match with a magnetic field direction. That is, a surface of the power receiver coil CLB may be substantially parallel to the water surface. When a power transmitter coil structure in which the power transmitter coil CLA and the relay coil CLC are connected to each other via a coupling body, the underwater vehicle 70 can enter and exit the power transmitter coil structure in the horizontal direction even when the power transmitter coil structure is disposed in the longitudinal direction. On the other hand, when the power transmitter coil structure in which the power transmitter coil CLA and the relay coil CLC are wound around the bobbin bn, when the power transmitter coil structure is disposed in the vertical direction, the underwater vehicle 70 may enter the inside of the power transmitter coil structure from openings of the bobbin bn positioned at an upper end and a lower end of the bobbin bn.

The present disclosure is useful as a power receiver apparatus and a power control method that prevent occurrence of magnetic saturation in the power receiver apparatus under water and improve power transmission efficiency from a power transmitter apparatus even when an outer periphery of a housing is surrounded by a magnetic body.

1. A power receiver apparatus which is movable under water and comprises a housing surrounded by a magnetic body on an outer periphery of the housing, the power receiver apparatus comprising:
a power receiver device configured to receive power wirelessly transmitted from a power transmitter apparatus;
a power supply device comprising a storage battery and configured to charge the storage battery based on the power received by the power receiver device;
a power detection device configured to repeatedly detect a power value during an operation of the power supply device; and
a processor configured to determine a control current value for operating the power supply device based on a comparison result between the power value which is detected by the power detection device and a previous power value which has been detected by the power detection device, and to control the operation of the power supply device based on the control current value.

2. The power receiver apparatus according to claim 1,
wherein the power detection device is configured to periodically detect the power value at a predetermined period during the operation of the power supply device, and
wherein the previous power value is a power value detected one period before in the predetermined period.

3. The power receiver apparatus according to claim 1, further comprising:
a current detection device configured to repeatedly detect a current value during the operation of the power supply device,
wherein the processor is configured to increase or decrease the control current value with reference to the current value detected by the current detection device.

4. The power receiver apparatus according to claim 3,
wherein in a case in which the processor has increased a previous control current value and in a case in which the power value detected by the power detection device is larger than the previous power value, the processor is configured to increase the current value detected by the current detection device by a predetermined amount.

5. The power receiver apparatus according to claim 3,
wherein in a case in which the processor has increased a previous control current value and in a case in which the power value detected by the power detection device is smaller than the previous power value, the processor is configured to decrease the current value detected by the current detection device by a predetermined amount.

6. The power receiver apparatus according to claim 3,
wherein in a case in which the processor has decreased a previous control current value and in a case in which the power value detected by the power detection device is larger than the previous power value, the processor is configured to decrease the current value detected by the current detection device by a predetermined amount.

7. The power receiver apparatus according to claim 3,
wherein in a case in which the processor has decreased a previous control current value and in a case in which the power value detected by the power detection device is smaller than the previous power value, the processor is configured to increase the current value detected by the current detection device by a predetermined amount.

8. A power control method performed by a power receiver apparatus, the power receiver apparatus being movable under water and comprising a housing surrounded by a magnetic body on an outer periphery of the housing, the power control method comprising:
receiving power wirelessly transmitted from a power transmitter apparatus;
charging a storage battery based on power received by a power supply device comprising the storage battery;
repeatedly detecting a power value during an operation of the power supply device;
determining a control current value for operating the power supply device based on a comparison result between the power value which is detected and a previous power value which has been detected; and
controlling an operation of the power supply device based on the control current value.
